(19) United States
(12) Patent Application Publication
(10) Pub. No.: US 2004/0125821 A1
(43) Pub. Date: Jul. 1, 2004

(54) Network synchronisation

(76) Inventor: Carmen Kuhl, Dortmund (DE)

Correspondence Address: HARRINGTON & SMITH, LLP, 4 RESEARCH DRIVE, SHELTON, CT, 06484-6212, US

(21) Appl. No.: 10/466,264

(22) PCT Filed: Jan. 21, 2002
(86) PCT No.: PCT/EP02/00551

(30) Foreign Application Priority Data
Jan. 22, 2001 (GB) 010570.0

(51) Int. Cl. H04L 7/00; H04J 3/06

(52) U.S. Cl. 370/503; 375/356

(57) ABSTRACT

Conventional networks, for example, a network of microprocessor controlled devices such as computer, printers, etc., have relied upon physical wire connections between each device on the network. Recently, however, has seen the emergence of wireless networks, in which the network connections are provided, typically, by a wireless radio link. One of these such networks is described in the Specification of the Bluetooth System v 1.0 B. However, synchronisation between independent wireless networks has some drawbacks which result in reduced bandwidth availability. The present invention aims to overcome these drawbacks.

The present invention relates to network synchronisation, and more particularly to the synchronisation of independent networks.

Conventional networks, for example, a network of microprocessor controlled devices such as computer, printers, etc., have relied upon physical wire connections between each device on the network. Due to the physical nature of the connection required, conventional networks are generally perceived to be fairly rigid in nature. For example, in order to add in an additional device on the network, the additional device must be physically connected to the network, and the network server may have to be informed that the additional device has been connected.

Recently, however, has seen the emergence of wireless networks, in which the network connections are provided, typically, by a wireless radio link. One of these such networks is described in the Specification of the Bluetooth System v1.0 B. Those skilled in the art will appreciate that other wireless networks also exist, and reference herein to Bluetooth is not intended to be limited thereto.

Bluetooth wireless technology allows users to make effortless, wireless and almost instant connections between various communications devices, such as mobile phones, computers, printers etc. Bluetooth provides short-range wireless connectivity and supports both point-to-point and point-to-multipoint connections. Currently, up to seven active ‘slave’ devices can communicate with a ‘master’ device, to form a ‘piconet’. Several of these piconets can be established and linked together in ad hoc ‘scatternets’, to allow communication among continually flexible configurations.

Bluetooth operates in the 2.4 GHz ISM band, which is globally available although the exact width and location of the band does vary from country to country. For example, in the US and Europe, a band of 83.5 MHz width is available; in this band, 79 RF channels spaced 1 MHz apart are defined. In some other countries, for example France, a smaller band is available having only 23 channels spaced 1 MHz apart. The channel is represented by a pseudo-random hopping sequence through available channels. The hopping sequence is unique for the piconet and is determined by the Bluetooth device address of the master device. The phase in the hopping sequence is determined by the Bluetooth clock of the master device. The channel is divided into time slots where each slot corresponds to an RF hop frequency. Consecutive hops correspond to different RF hopping frequencies. The nominal hop rate is 1600 hops per second. All Bluetooth devices in a given piconet are time and frequency hop synchronised to the channel.

Accordingly, one aim of the present invention is improve the synchronisation between piconets and scatternets.

According to a first aspect of the present invention, there is provided a method of connecting a new device to a wireless network of devices, each of the devices having a clock, wherein the network of devices comprises a master device for controlling a plurality of slave devices and wherein the devices within the network of devices are synchronised to a common clock, the method comprising: the new device paging a device of the network of devices to establish a connection; establishing the difference between the clock of the new device and the common clock; applying the clock difference to the clock of the new device, thereby synchronising the clock of the new device to the common clock.

According to a second aspect of the present invention, there is provided a method of connecting a new device to a wireless network of devices, each of the devices having a clock, wherein the network of devices comprises a master device for controlling a plurality of slave devices and wherein the devices within the network of devices are synchronised to a common clock, the method comprising: paging the new device from one of the plurality of slave devices to establish a connection; establishing the difference between the clock of the new device and the common clock; applying the clock difference to the clock of the new device, thereby synchronising the clock of the new device to the common clock.

According to a third aspect of the present invention, there is provided a device for connecting to a wireless network of devices, each of the devices having a clock, wherein the network of devices comprises a master device for controlling a plurality of slave devices and wherein the devices within the network of devices are synchronised to a common clock, comprising: a transmitter for paging a device of the network of devices to establish a connection; a processor for establishing the difference between the clock of the device and the common clock; means for applying the clock difference to the clock of the device, thereby synchronising the clock of the new device to the common clock.

According to a fourth aspect of the present invention, there is provided a device for connecting to a wireless network of devices, each of the devices having a clock, wherein the network of devices comprises a master device for controlling a plurality of slave devices and wherein the devices within the network of devices are synchronised to a common clock, the method comprising: a transmitter for paging the new device from one of the plurality of slave devices to establish a connection; a processor for establishing the difference between the clock of the new device and the common clock; and means for applying the clock difference to the clock of the new device, thereby synchronising the clock of the new device to the common clock.

According to a fifth aspect of the present invention, there is a provided A method of connecting a new device to a wireless network of devices, each of the devices having a clock, wherein the network of devices comprises a master device for controlling a plurality of slave devices and wherein the devices within each network of devices are synchronised to a common clock, the method comprising the steps of: connecting the new device to the wireless network of devices thereby forming two wireless networks of devices; obtaining the common clock of one of the networks; applying the obtained clock to the other network, thereby synchronising both networks to the same clock.

One of the problems associated with the creation of scatternets is that individual piconets run on independent clocks. This can lead to a loss of efficiency upon the creation of a scatternet, due to timing differences. The present invention advantageously seeks to overcome such problems.

The invention will now be described, by way of example only, with reference to the accompanying diagrams, in which:

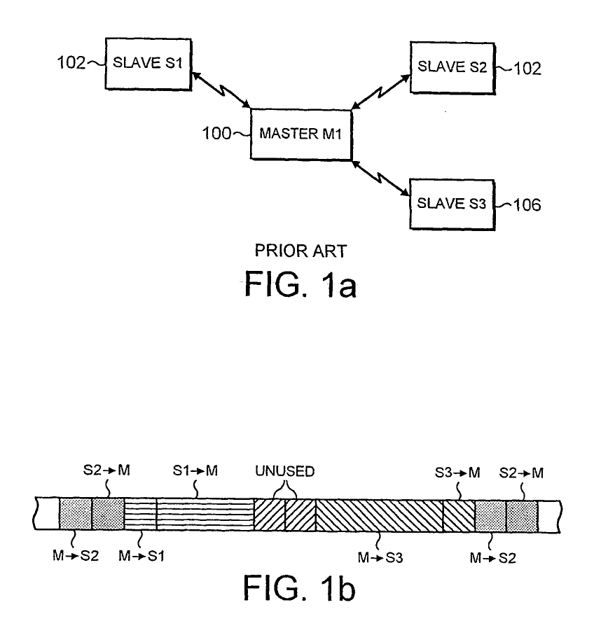

FIG. 1a shows a piconet configuration according to the prior art;

FIG. 1b shows an example of the data traffic for the piconet of FIG. 1a;

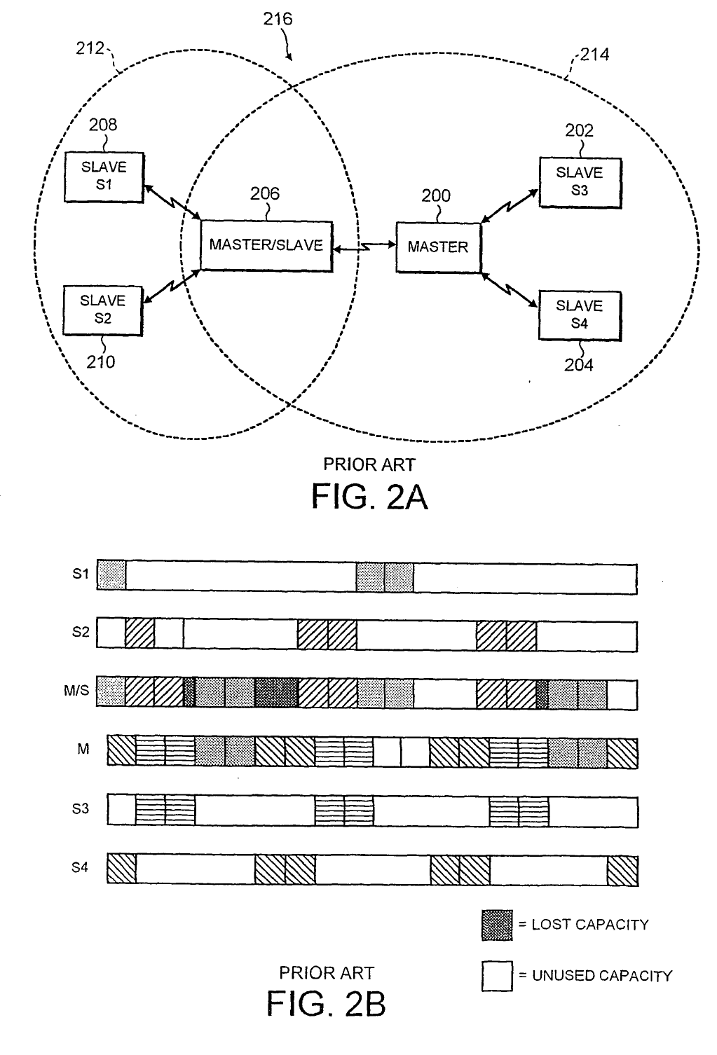

FIG. 2a shows a block diagram of a scatternet formed by the linking of two independent piconets according to the prior art;

FIG. 2b shows an example of the data traffic between the different devices of the scatternet shown in FIG. 2a;

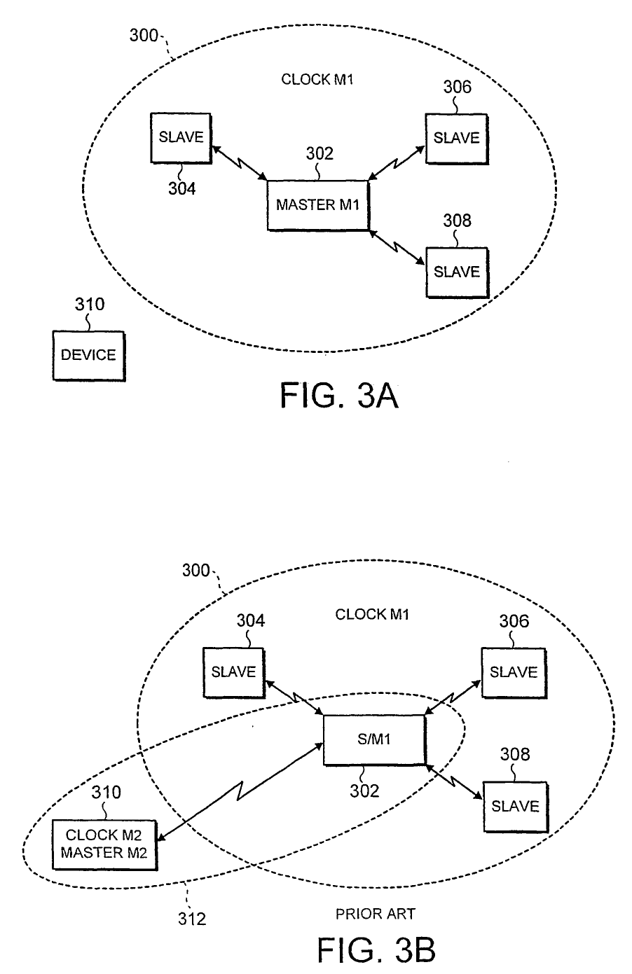

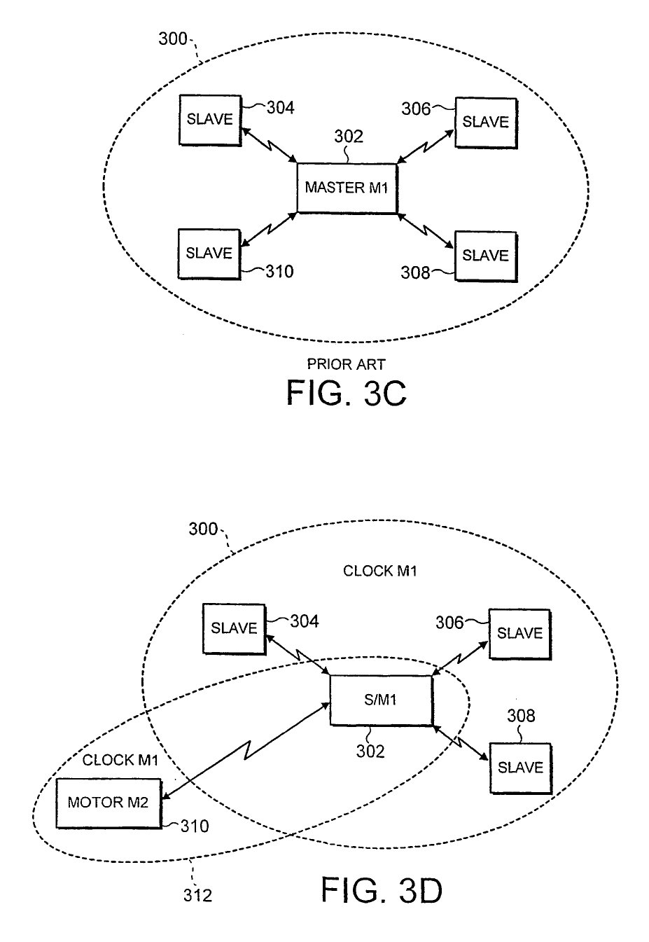

FIG. 3a shows a scenario wherein a single device 310 joins an existing piconet;

FIG. 3b shows the connection made according to the prior art;

FIG. 3c shows the same scenario as shown in FIG. 3a, wherein the device 310 has connected to the piconet 300 and has subsequently performed a role-switch according to the prior art;

FIG. 3d shows the same scenario as shown in FIG. 3b, wherein clock synchronisation has taken place according to the present invention;

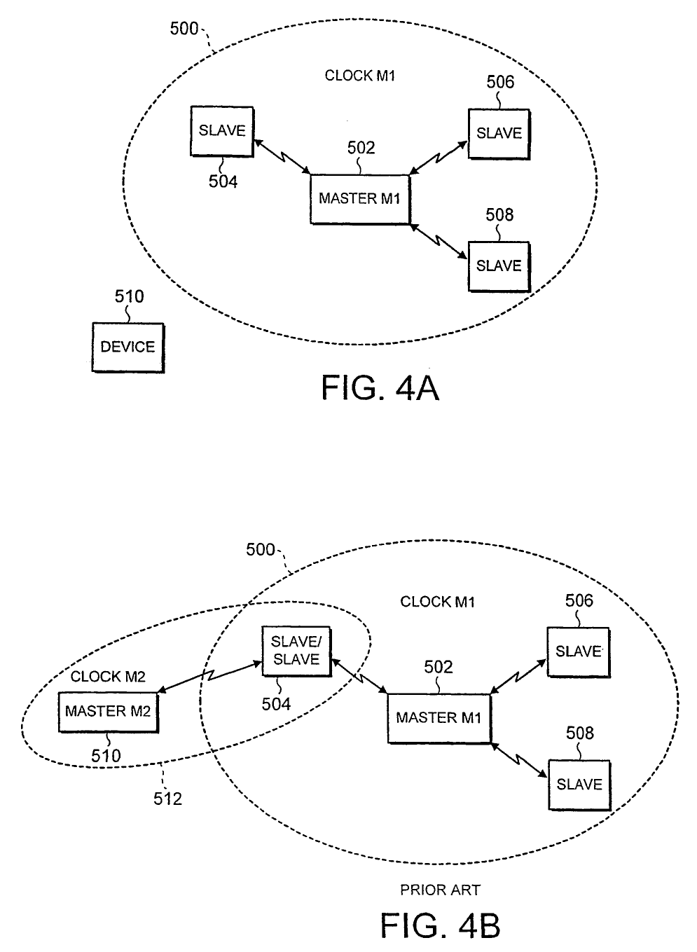

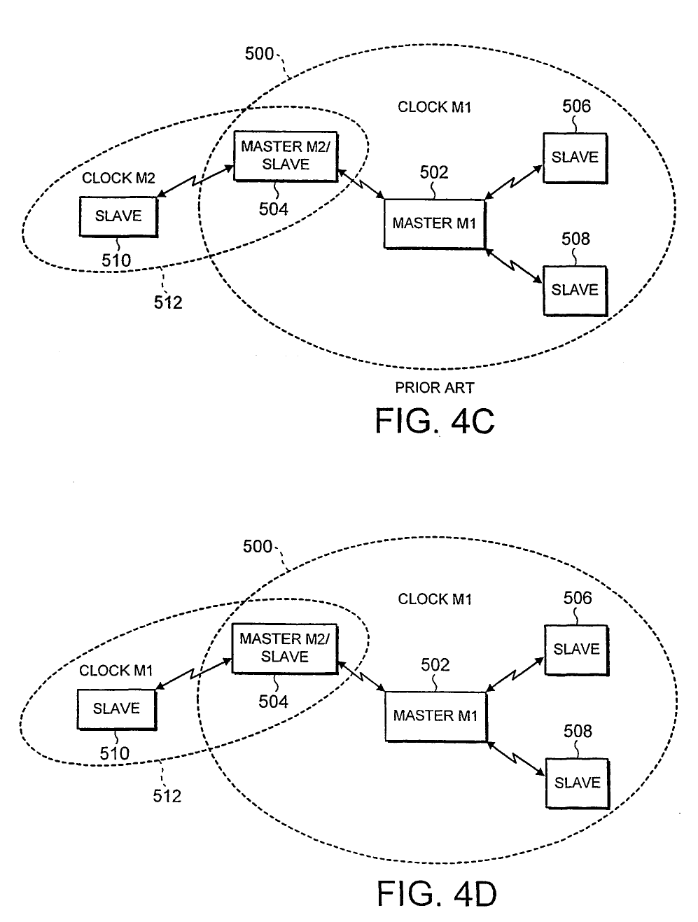

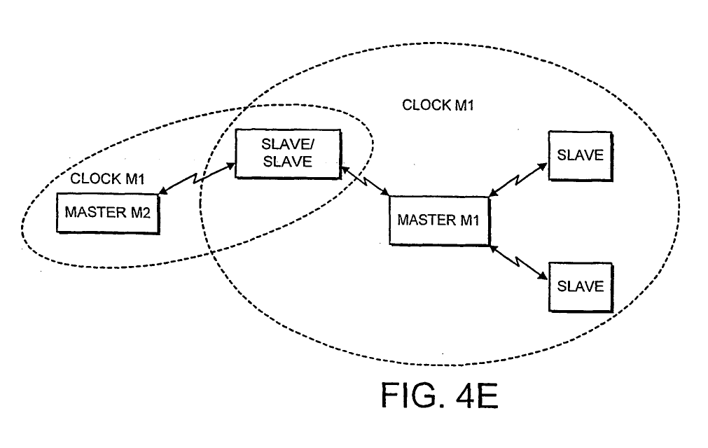

FIG. 4a shows a further scenario in which a device joins a piconet;

FIG. 4b shows the device 510 joining a slave device 504 according to the prior art;

FIG. 4c shows an alternative way in which the device 510 may join a slave device 504 according to the prior art;

FIGS. 4d and 4e show connection scenarios according to the present invention;

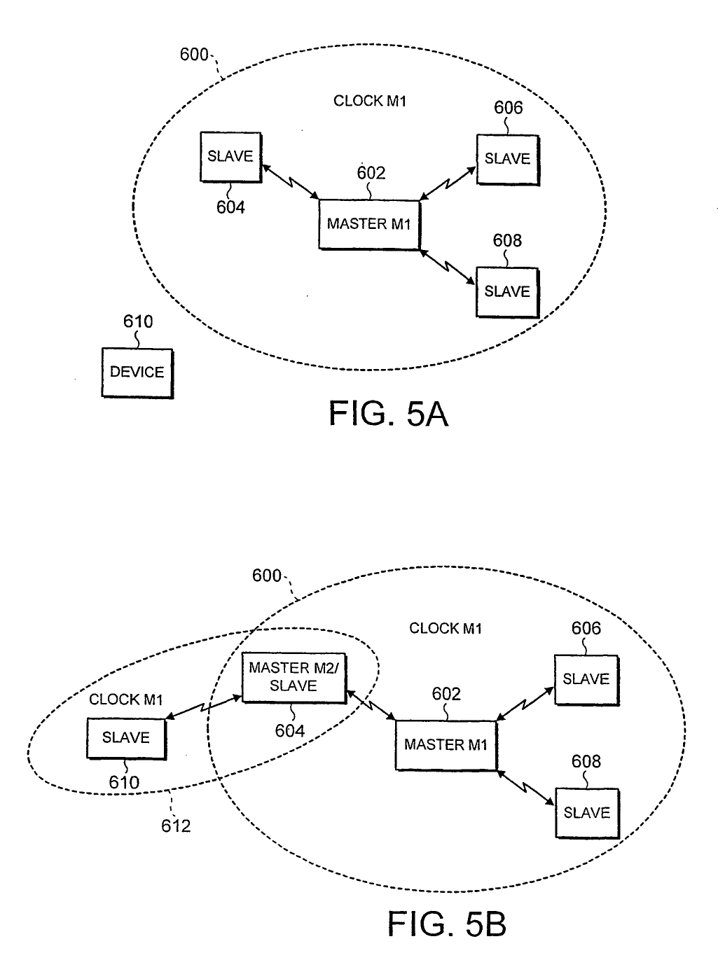

FIG. 5 shows a further connection scenario;

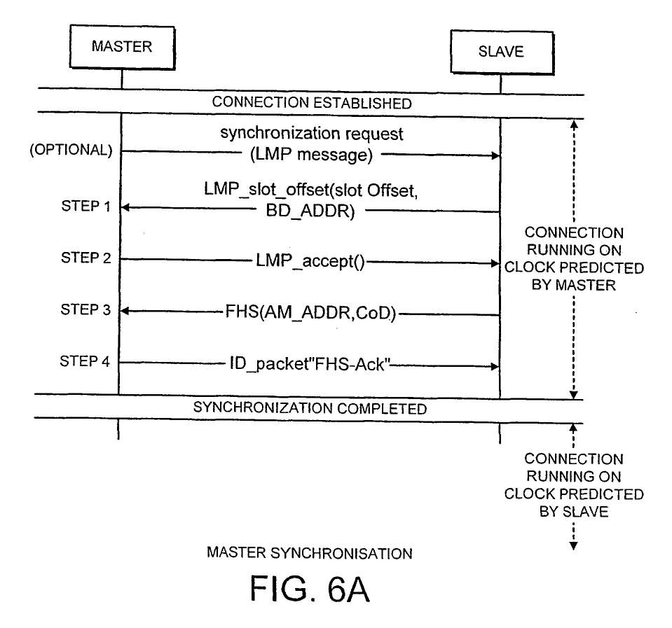

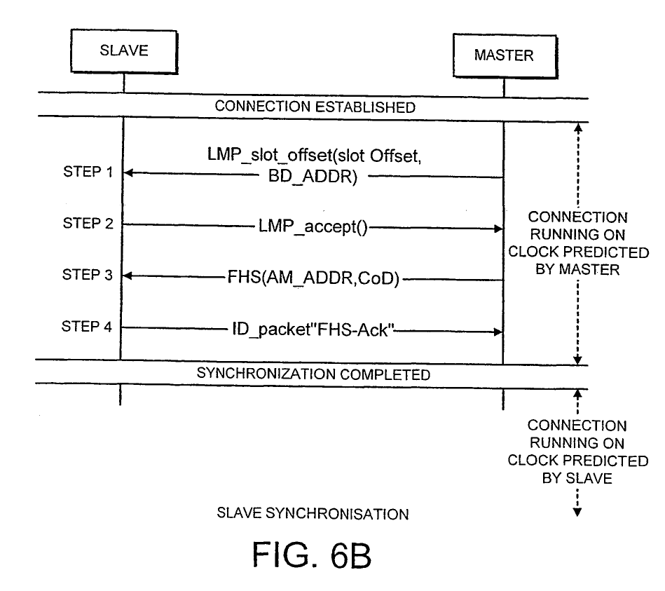

FIG. 6 shows one embodiment for obtaining clock synchronisation according to the present invention;

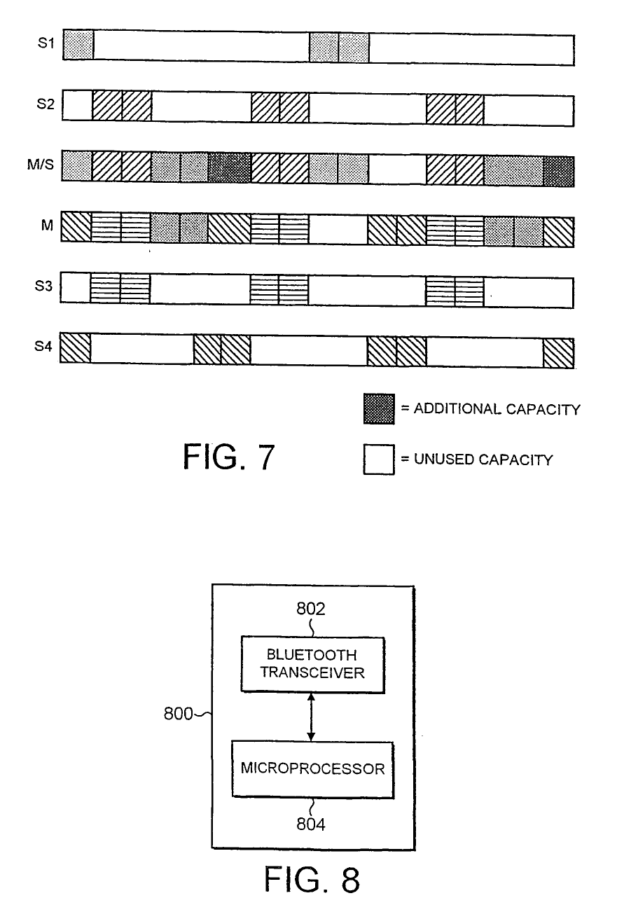

FIG. 7 shows an example of the data traffic between the different devices of the scatternet shown in FIG. 2a using clock synchronisation according to the present invention; and

FIG. 8 shows a device according to an embodiment of the present invention.

FIG. 1a shows a piconet configuration according to the prior art. A master device (M1) 100 communicates with a number of slave devices (S1, S2 and S3) 102, 104 and 106 respectively. The number of slave devices is variable, and the maximum number of slave devices which can be connected to the master device is dependent on the capacity of the master device and the particular communication characteristics involved. In a Bluetooth configuration, the maximum number of active slave devices is currently seven.

The master device, of which there can only be one in a piconet, initiates the connection of a slave device to the piconet. The piconet operates in a time division duplex (TDD) arrangement. In a TDD network a single packet of information is transmitted in the network at a time and the slave devices are synchronised to a common time frame by the master device. This time frame consists of a series of time slots of equal length. Normally, each data packet transmitted in the piconet has its start aligned with the start of a time slot, and (in case of single slot packets) adjacent time slots are assigned for respectively transmission and reception by the master device. When the master device is performing point-to-point communication a transmitted data packet is addressed to a particular slave device which replies to the master device by transmitting a data packet addressed to the master device in the time slot immediately following the packet sent by the master device. Any time misalignment between the master and slave devices is corrected by adjusting the timing of the slave devices.

FIG. 1b shows an example of the data traffic for the piconet of FIG. 1a. The master device 100 determines the slot timing and allocates bandwidth to each of the slave devices as appropriate. The master device also determines the frequency hopping sequence which is used by the slave devices. In the example shown, the master device M1 transmits a single slot of data to slave device S2. Slave device S2 responds to the master device M1 by transmitting a single slot of data. Subsequently, the master device M1 transmits a single slot of data to slave device S1. Slave device S1 responds by transmitting three slots of data to the master device M1. The following two time slots are unused, after which master device M1 transmits five slots of data to slave device S3. Slave device S3 responds by transmitting one slot of data to the master device M1.

The allocation of bandwidth, including the number of time slots allocated to a particular device will be well understood by those skilled in the art, and will not be discussed herein in further detail.

If an additional slave device joins the existing piconet, the slave device will be forced to synchronise itself (both in terms of time and frequency hopping synchronisation) with the master device of the piconet. This ensures that all devices within a piconet are synchronised to the master device in a given piconet.

As previously mentioned, piconets may be linked together to form scatternets. As already indicated, one problem with forming scatternets is that each piconet has its own timing and frequency hopping scheme. Problems consequently arise in having to deal with multiple unsynchronised clocks.

FIG. 2a shows a block diagram of a scatternet formed by the linking of two independent piconets according to the prior art. Two piconets, 212 and 214 are shown. The first piconet 212 comprises a master device 206, and two slave devices S1 and S2, indicated at 208 and 210. The second piconet 214 comprises a master device 200 and three slave devices 202, 204 and 206. Each piconet independently operates as previously outlined. The two piconets have been linked to form a scatternet 216. The linking is provided by the participation of device 206 on both piconets 212 and 214. In this configuration, the device 206 operates as a slave device for communication to the master device 200, since only one master device can exist at a time. However, for communications within the piconet 212, the device 206 operates as a master device as previously described.

FIG. 2b shows an example of the data traffic between the different devices of the scatternet 216 shown in FIG. 2a. Looking at the piconet 214, it can be seen that the master device 200 maintains synchronous connections (SCO) between the slave devices as well as an asynchronous connection between the master/slave device 206. It can also be seen that, even in this configuration, the master device 200 has some free slots available. In contrast to this, the master/slave device 206 loses some of its capacity when switching between the two different piconet clocks, indicated by solid shading in FIG. 2b. As a result, the master/slave device 206 can only handle a single synchronous connection (between slave device S2), while the remaining bandwidth is used by two asynchronous links (ACL) towards the slave device S2 and the master device 200, and also by the piconet switches.

As previously discussed, many of the problems arising from scatternets are mostly based on the fact that each piconet owns a unique slot timing. The present invention aims to overcome such problems by synchronising the clocks between piconets such that the overall scatternet is synchronised to a single common clock. In the prior art, only slave devices were required to synchronise to the clocks of master devices. This was achieved by adding a timing offset to each slave device's own native clock. In the present invention, the same also applies for master devices.

Below are outlined a number of scenarios which aim to show how the above-mentioned problems associated with the prior art may be overcome using the present invention. In the following examples, unless otherwise indicated, it is assumed that the newly joining device carries out the paging procedure. As a result the newly joining device will, according to Bluetooth convention, become the master device of the established connection and thereby defines the corresponding timing as well as the frequency hopping sequence. This has to be taken into consideration when considering that the single, newly joining device needs to adapt its clock. It should be further be noted that only the timing will be adapted; the frequency hopping sequence is still determined by the master device. It should be noted that in the following example, only a single device is shown joining an existing piconet. Those skilled in the art will appreciate that such a single device may also already be part of an additional piconet, however, for reasons of clarity, only the single device is shown.

FIG. 3a shows a scenario wherein a single device 310 joins an existing piconet 300 comprising a master device (M1) 302, and slave devices 304, 306 and 308.

FIG. 3b shows the connection made according to the prior art. The device 310 connects to the piconet 300 and, as explained above, becomes the master device M2 for the scatternet. The master device (M1) continues to function as the master device for the piconet 300, but it also assumes the role of a slave device in the scatternet. The master device (M2) 310 runs on its own clock, however the piconet 300 still runs at the clock of original master device (M1) 302. Communication between the master device (M2) 310 and the master/slave device 302 will be based on the clock of the master device (M2) 310. In this scenario, where no clock synchronisation has taken place, bandwidth losses (as illustrated in FIG. 2b) will result due to the clock differences.

FIG. 3c shows the same scenario as shown in FIG. 3a, but in this case the device 310 has connected to the piconet 300 and has performed a role-switch upon connection establishment according to the prior art. In this case the master device becomes a slave device. In this example, the net result is the same as if the master device (M1) 302 had performed the paging operation.

FIG. 3d shows the same scenario as shown in FIG. 3b, but in this case clock synchronisation has taken place according to the present invention. The master device (M2) 310 adopts the clock of the existing piconet. This results in both piconets 300 and 312 being synchronised to the same clock, that of the existing piconet.

Further details describing how the clock synchronisation may be achieved are given later.

FIG. 4a shows a further scenario in which a device 510 joins a piconet 500 comprising a master device (M1) 502 and slave devices 504, 506 and 508. FIGS. 4b and 4c show how the connection is established according to the prior art. The device 510 connects to the slave device 504. The device 510 is the master (M2) device since it has initiated the paging. The slave device 504 functions both as an existing slave device to master device (M1) 502 of the existing piconet, and also functions as a slave device for the piconet 512, under control of the master device (M2) 510. A connection in this manner results in different clocks being used for each of the piconets 500 and 512, resulting in capacity losses.

FIGS. 4d and 4e show connection scenarios according to the present invention. In addition to the connection as made in FIG. 4b, the device 510 performs a role switch, thereby becoming a slave device, and thereby causing the slave device 504 to become a master/slave device, as shown in FIG. 4c. However, this in itself does not solve the problem of synchronisation. Time synchronisation is then performed, and the result of this is shown in FIG. 4d, wherein both piconets are operating under the same clock, that of the master device (M1) 502.

It is not necessary though to perform the role switch prior to performing the time synchronisation, and this is shown in FIG. 4e. FIG. 4e is effectively the same as FIG. 4b but has the additional step of time synchronisation performed.

A further scenario is presented in FIG. 5a, wherein a new single device is connected to a piconet as a slave device. It is therefore assumed that the joining device is paged from a device which is already synchronised to either an established piconet or scatternet. In this case, the joining device will be connected as a slave device. The joining device will therefore have to adapt both its timing and frequency hopping scheme.

When the joining device is paged from a piconet master device, it will be added to the original piconet. During the connection procedure the master device transmits timing parameters relating to the piconet itself. Previously, the transmitted timing parameters were based solely on the timing parameters of the master device itself. A common piconet/scatternet timing provides significant advantages over the prior art, since it is possible that the timing parameters of the master device could have been previously derived from one or more other devices. For example, the master device could already have adapted its timing to synchronise to an existing piconet. Such a scenario is illustrated in FIG. 5. In this case, the slave device has to provide both its existing slave function and to provide a master function to service the new slave device, as shown in FIG. 5b. The timing parameters exchanged during the connection procedure will again be derived from the existing piconet which will lead to an immediate synchronisation of the new device. While the frequency hopping sequence will be determined by the master device (as before), the clock of the new piconet is defined by the existing piconet.

Since the new device gets synchronised during the connection procedure, the performance of a role switch produces the same results as previously. However, the timing parameters are those of the piconet or the scatternet, not necessarily those of the master device to which it is joined.

When piconets or scatternets join together negotiation needs to take place in order to determine which of the previously independent entities will adapt its timing. It should be noted that precise details regarding such negotiation criteria and mechanisms are not presented herein. However, should timing synchronisation be refused by the devices involved in a new connection, it is not possible to merge the existing piconets or scatternets into a single synchronised scatternet.

FIGS. 6a and 6b show embodiments for obtaining clock synchronisation according to the present invention and shows examples of the messaging sequences between a master and slave device. FIG. 6a shows the messaging sequences to enable a device joining as a master device to be synchronised, and FIG. 6b shows the corresponding situation for synchronising a new slave device.

FIGS. 6a and 6b assume that a connection has already been established. Details regarding how a connection is established are not given here as they will be readily understood by those skilled in the art.

Referring to FIG. 6a, the steps involved are:

An optional step may initially be taken by the master device thereby requesting synchronisation by the slave device.

Step 1:

Since the new master device needs to align its timing to the piconet of which it is joining, it needs to obtain the piconet timing information from the slave device to which it joins. The slave sends a time alignment message (for example, LMP_slot_offset) in the first slave-to-master slot. This message provides information regarding the delay between slots in the old and the new piconet. The timing for the corresponding transmission is still, however, based on the new master device's master clock.

Step 2:

Having received the LMP_slot_offset message from the slave, the master acknowledges the message by, for example, sending LMP accepted.

Step 3:

In addition to the slot delay between the different piconets, information about the piconet clock itself is required. The master therefore needs to obtain a packet (e.g. FHS packet) which contains the relevant clock information from the slave device. The timing for the corresponding transmission is still based on the new master device's native clock.

Step 4:

In response to the received clock information, the master may, for example, send an FHS acknowledgement message, thereby informing the slave device that all timing related information for the clock synchronisation has been received and accepted. If the master does not respond with an FHS acknowledge message, the connection will be cut off due to the fact that no synchronisation has taken place. The timing for the corresponding transmission is still based on the clock of the new master device.

Step 5:

Following the next master-to-slave transmission, both master and slave devices are synchronised to the clock of the original piconet. It should be noted that although the clock has changed, the hopping sequence is still determined by the master device.

For synchronisation of a new slave device the procedure is largely identical to that described above. However, instead of being requested by the master or being initiated by the slave in the first slave-to-master slot, the master now actively transmits the corresponding timing information to the slave. In the procedures according to the present invention the master and slave roles generally have to be exchanged when synchronising a slave device in a scatternet.

The advantages provided by the present invention are clearly illustrated in FIG. 7. FIG. 7 shows an example of the data traffic between the different devices of the scatternet 216 shown in FIG. 2a once synchronisation according to the present invention has been performed. The combined master/slave device no longer has to switch between different clocks since the whole scatternet is synchronised to a single clock. As previously described, the combined master/slave device only has to adapt to the frequency hopping sequence of the appropriate piconet. Consequently, the lost capacity resulting from the clock switches (see FIG. 2b) is regained, and the overall bandwidth is increased significantly, as indicated by the solid shading.

FIG. 8 is a block diagram of an embodiment of a device according to the present invention. A device 800 comprises a transceiver 802, which could be a Bluetooth transceiver. Such a transceiver is capable of performing all the functions necessary to communicate with, for example, other Bluetooth devices, as will be appreciated by those skilled in the art. Additionally, a microprocessor 804 may communicate with the transceiver 802 in order to control the transceiver in accordance with the present invention. Alternatively, the functionality of the microprocessor 804 may be incorporated into the Bluetooth transceiver 802. Depending on whether the device is functioning as a master or slave device, the microprocessor may function in accordance with FIG. 6a or 6b. For example, the microprocessor may receive information relating to a clock (via the transceiver 802), and may then adapt it's own clock to provide synchronisation. Alternatively, the microprocessor may control the transceiver to ensure that timing information is transmitted to a newly joining device.

Among the obvious advantages which an increase in bandwidth brings is an improvement in the quality of service (QoS). Furthermore, connections which involve multiple ‘hops’, from one device to another, can be performed in a more flexible and efficient way, for example, by allowing SCO and ACL links (which are used to transmit LMP messages related to the SCO connection) in parallel. While in asynchronous piconets LMP messages might overwrite SCO packets, due to higher priority and lack of available bandwidth, with synchronised piconets the ACL slots can be transmitted between consecutive SCO packets. Additionally, the increases enable larger data packets to be supported, such as HV2 and HV3 packets.

1. A method of connecting a new device to a wireless network of devices, each of the devices having a clock, wherein the network of devices comprises a master device for controlling a plurality of slave devices and wherein the devices within the network of devices are synchronised to a common clock, the method comprising:
the new device paging a device of the network of devices to establish a connection;
establishing the difference between the clock of the new device and the common clock;
applying the clock difference to the clock of the new device, thereby synchronising the clock of the new device to the common clock.

2. The method of claim 1, wherein the new device is part of an existing wireless network of devices, the method further comprising applying the clock difference to the devices in the existing network of devices.

3. The method of claim 1 or 2, further comprising, upon connection, the new device requesting information relating to the common clock.

4. The method of claim 2 or 3, further comprising the paged device sending information to the new device relating to the common clock.

5. The method of claim 4, wherein the step of sending information relating to the common clock is in response to the request for information relating to the common clock.

6. The method of any preceding claim, wherein each device is a Bluetooth device.

7. A method of connecting a new device to a wireless network of devices, each of the devices having a clock, wherein the network of devices comprises a master device for controlling a plurality of slave devices and wherein the devices within the network of devices are synchronised to a common clock, the method comprising:
paging the new device from one of the plurality of slave devices to establish a connection;
establishing the difference between the clock of the new device and the common clock;
applying the clock difference to the clock of the new device, thereby synchronising the clock of the new device to the common clock.

8 The method of claim 7, wherein the new device is part of an existing wireless network of devices, the method further comprising applying the clock difference to the devices in the existing network of devices.

9. The method of claim 7 or 8, further comprising, upon connection, the new device requesting information relating to the common clock.

10. The method of claim 8 or 9, further comprising the paged device sending information to the new device relating to the common clock.

11. The method of claim 10, wherein the step of sending information relating to the common clock is in response to the request for information relating to the common clock.

12. The method of any of claims 7 to 11, wherein each device is a Bluetooth device.

13. A device for connecting to a wireless network of devices, each of the devices having a clock, wherein the network of devices comprises a master device for controlling a plurality of slave devices and wherein the devices within the network of devices are synchronised to a common clock, comprising:
a transmitter for paging a device of the network of devices to establish a connection;
a processor for establishing the difference between the clock of the device and the common clock;
means for applying the clock difference to the clock of the device, thereby synchronising the clock of the new device to the common clock.

14. The device of claim 13, wherein the device is part of an existing wireless network of devices, wherein the means for applying the clock difference is adapted to apply the clock difference to the devices in the existing network of devices.

15. The device of claim 13 or 14, wherein, upon connection, the transmitter is adapted to transmit a request for information relating to the common clock.

16. The device of claim 13 or 14, wherein the receiver receives information from the paged device relating to the common clock.

17. The device of claim 16, wherein the receiver receives information from the paged device in response to the transmitted request.

18. The device of any of claims 13 to 17, wherein each device is a Bluetooth device.

19. The device of any of claims 13 to 18 operating according to the method of any of claims 1 to 6.

20. A device for connecting to a wireless network of devices, each of the devices having a clock, wherein the network of devices comprises a master device for controlling a plurality of slave devices and wherein the devices within the network of devices are synchronised to a common clock, the method comprising:
a transmitter for paging the new device from one of the plurality of slave devices to establish a connection;
a processor for establishing the difference between the clock of the new device and the common clock; and
means for applying the clock difference to the clock of the new device, thereby synchronising the clock of the new device to the common clock.

21 The device of claim 20, wherein the device is part of an existing wireless network of devices, wherein the means for applying the applying the clock difference is adapted to apply the clock difference to the devices in the existing network of devices.

22. The device of claim 20 or 21, wherein, upon connection, the transmitter transmits a request for information relating to the common clock.

23. The device of claim 21 or 22, wherein the receiver receives information relating to the common clock.

24. The device of claim 23, wherein the receiver receives information relating to the common clock is in response to the transmitted request.

25. The device of any of claims 20 to 24, wherein each device is a Bluetooth device.

26. The device of any of claims 20 to 25 operating according to the method of any of claims 7 to 12.

27. A system for connecting a device to a wireless network of devices, comprising a device as claimed in any of claims 13 to 26.

28. A system for connecting a device to a wireless network of devices substantially as hereinbefore described, with reference to any one or combination of FIGS. 3d, 4d, 4e, 5, 6 and 7.

29. A method of connecting a new device to a wireless network of devices substantially as hereinbefore described, with reference to any one or combination of FIGS. 3d, 4d, 4e, 5, 6 and 7.

30. A device for connecting to a wireless network of devices substantially as hereinbefore described, with reference to any one or combination of FIGS. 3d, 4d, 4e, 5, 6 and 7.
